(19) United States
(12) Patent Application Publication
(10) Pub. No.: US 2025/0210901 A1
(43) Pub. Date: Jun. 26, 2025

(54) SOLAR OUTDOOR DECORATIVE LIGHT GROUP AND PROTECTION BOX FOR POWER EXTENSION LINE

(71) Applicant: SHITING HE, Zhumadian (CN)

(72) Inventor: SHITING HE, Zhumadian (CN)

(21) Appl. No.: 18/396,012

(22) Filed: Dec. 26, 2023

(51) Int. Cl. H01R 13/422; F21S 9/03

(52) U.S. Cl. CPC H01R 13/422; F21S 9/032

(57) ABSTRACT

The present disclosure discloses a protection box for a power supply extension line, which includes a lower shell and an upper shell. The lower shell and the upper shell are movably connected together, both ends of the lower shell and the upper shell are provided with a groove. Each groove is embedded with a waterproof rubber pad, a limit component is provided in the lower shell and the upper shell. Each limit component includes two relatively arranged sleeves, the sleeve is rotationally connected with a vertical rod, an end of each vertical rod away from the sleeve is fixedly connected with a baffle, the baffle is inclined. The present disclosure can effectively prevent water and dust from entering a connection position 10 between the male and female plugs in most cases by installing a protective box at the connection position, thereby extending the service life of the system.

### TECHNICAL FIELD

The present disclosure relates to the field of light string connection technologies, and in particular, to a solar outdoor decorative light group and a protection box for a power extension line.

### BACKGROUND

With a continuous development of lighting industry and technological progress, people's requirements for lighting string lights are becoming more and more diverse. A traditional connection method of one plug connector for one light is changing to one plug connector for multiple lights. Due to the need for lighting fixtures to emit light for a long time to achieve a decorative effect and a high-power consumption of multiple lighting fixtures, in order to provide electricity to lighting fixtures while saving electricity, a researcher has developed a solar powered lamp group.

An existing solar outdoor decorative light group is mostly composed of a single solar power supply component and a light string component. A power is provided to the light group by installing photovoltaic panels outdoors, with a relatively simple structure. Each time the light group is turned on or off, manual operation is required near the light group.

Although existing solar outdoor decorative light groups can save electricity to a certain extent, due to a fact that solar powered light groups are mostly used outdoors, there is a lack of effective protection at a joint of the light group connection line and the photovoltaic panel connection line. Outdoor rainwater or snow water is prone to invade from the joint of the connection line, which causes a short circuit and shortening the service life of the entire solar light group. Moreover, manual operation is required for each turning on and off the light group, an operation is relatively cumbersome, which results in a poor user experience.

### SUMMARY

A purpose of the present disclosure is to provide a solar outdoor decorative lamp group and a protection box for a power extension line, to solve a problem proposed in the background technology,

In order to achieve the above purpose, the present disclosure provides the following technical solution: a protection box for a power extension line, including a lower shell and an upper shell, where the lower shell and the upper shell are movably connected together, both ends of the lower shell and the upper shell are provided with a groove, each groove is embedded with a waterproof rubber pad;
both the lower shell and the upper shell are respectively provided with a limit component, each limit component includes two oppositely arranged sleeves, a vertical rod is rotatably connected to one sleeve, an end of each vertical rod away from the sleeve is fixedly connected to a baffle, the baffle is inclined.

In an embodiment of the present disclosure, a connection position between the lower shell and the upper shell is made of a hard but flexible material.

In an embodiment of the present disclosure, the upper shell is hinged with multiple buckles, the lower shell is provided with a slot corresponding to the number of buckles.

A solar outdoor decorative light group with the protection box for a power extension line, including an energy supply mechanism, a control mechanism, a connection mechanism, and an execution mechanism, the energy supply mechanism includes a photovoltaic panel and a battery that continuously provide power to the decorative light group, the battery is provided with a topological charging interface;
the control mechanism includes a triggering mechanism and an electronic control part for turning on the photovoltaic panel and the battery, the triggering mechanism includes a proximity physical switch, a voice controller, and a remote-control switch, after any one of the proximity physical switch, the voice controller, and the remote control switch is triggered, the electronic control part controls the execution mechanism to turn on or off;
the connection mechanism includes a main connection line and multiple branch connection lines, an end of the main connection line is connected to the control mechanism, and the other end of the main connection line is connected to a corresponding branch connection line through an extension assembly, the connection mechanism further includes one or more T-shaped interfaces that connect the branch connection line in pairwise;
the execution mechanism includes multiple light-emitting elements, a connection end of each light-emitting element is provided with a connector adapted to an unconnected end of the T-shaped interface.

In an embodiment of the present disclosure, the energy supply mechanism is further provided with a light automatic tracking module to keep a rotation of photovoltaic panel in a same direction and frequency with the sun.

In an embodiment of the present disclosure, the extension assembly includes a male plug installed at an end of the main connection line away from the control mechanism, and a female plug installed at an end of the branch connection line near the male plug, where the male plug and the female plug are plugged together.

In an embodiment of the present disclosure, the control mechanism further includes a temperature sensor, when the temperature sensor determines that a temperature exceeds a reasonable range, the electronic control part controls the execution mechanism to turn off.

In an embodiment of the present disclosure, the control mechanism further includes a humidity sensor, and after the humidity sensor determines that a humidity exceeds a reasonable range, the electronic control part controls the execution mechanism to turn off.

In an embodiment of the present disclosure, a waterproof plug or an extension joint is provided at an end of the branch connection line away from the main connection line, the male plug is a high-voltage to low-voltage joint.

In an embodiment of the present disclosure, the light-emitting element is a light bulb or a light string.

The beneficial effects of the present disclosure are as follows:
1. The present disclosure can effectively prevent water and dust from entering a connection position between the male and female plugs in most cases by providing with a protective box at the connection position, thereby extending the service life of the system.
2. The present disclosure can use various methods such as remote control, manual control, voice control, etc. to control an opening or closing of the light group through a mutual cooperation of the control mechanism and the connection mechanism, thereby further improving a control experience of a user.
3. The present disclosure uses a light sensor and a motor to form a movable mechanism, which enables the photovoltaic panel to automatically track light. In weather with insufficient light, it enters a sleep state, reducing energy consumption and further improving a photovoltaic conversion efficiency of the photovoltaic panel.

### BRIEF DESCRIPTION OF DRAWINGS

FIG. 1 is a schematic diagram of a three-dimensional structure of a protection box for a power supply extension line used in the present disclosure.

FIG. 2 is an enlarged schematic diagram of the present disclosure used to demonstrate a structure at position A in FIG. 1.

FIG. 3 is a schematic diagram of an enlarged structure used in the present disclosure to demonstrate a position of B in FIG. 1.

FIG. 4 is an overall architecture diagram of a solar outdoor decorative lamp group used in the present disclosure.

FIG. 5 is a block diagram of the present disclosure used to demonstrate a control mechanism.

Reference number: 1. Energy supply mechanism; 2. Control mechanism; 21. Proximity physical switch; 22. Voice controller; 23. Remote-control switch; 24. Temperature sensor; 25. Humidity sensor; 3. Connection mechanism; 31. Main connection line; 32. Branch connection line; 33. T-shaped interface; 34. Waterproof plug; 35. Extension joint; 4. Execution mechanism; 41. Light-emitting element; 42. Connector; S. Male plug; 6. Female plug; 7. Lower shell; 8. Upper shell; 9. Waterproof rubber pad; 10. Sleeve; 11. Vertical rod; 12. Baffle; 13. Buckle.

### DESCRIPTION OF EMBODIMENTS

The technical solution in the embodiments of the present disclosure will be clearly and completely described in combination with the drawings. Obviously, the described embodiments are only a part of the embodiments of the present disclosure, not all of them. Based on the embodiments in the present disclosure, all other embodiments obtained by ordinary technicians in the art without creative work fall within the protection scope of the present disclosure.

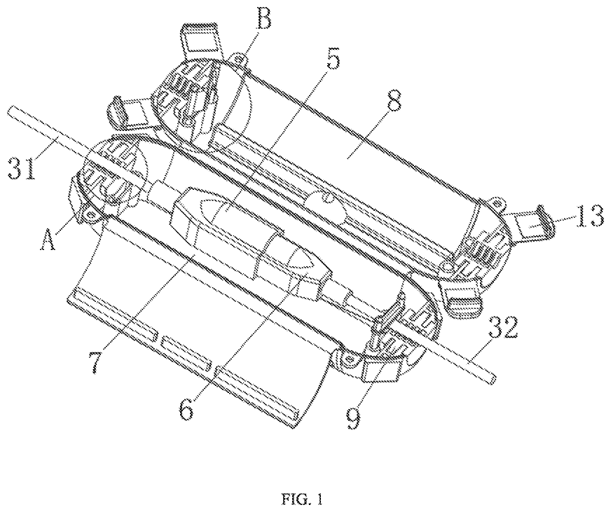

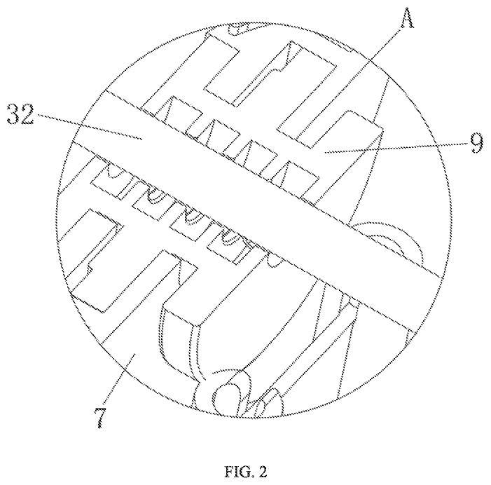

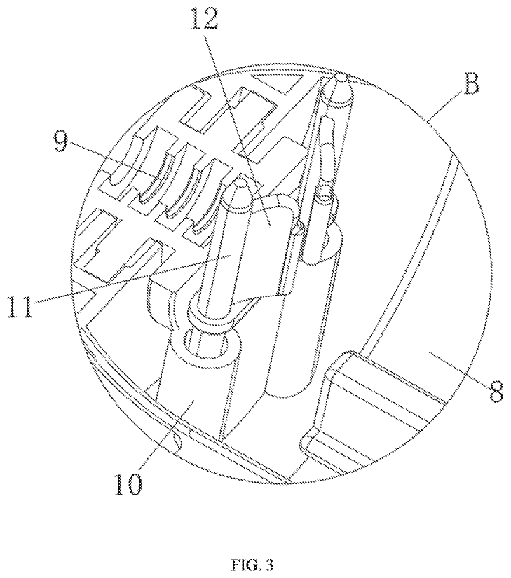

As shown in FIGS. 1 to 3, an embodiment of the present disclosure provides a protection box for a power extension line, including a lower shell 7 and an upper shell 8. The lower shell 7 is movably connected to the upper shell 8, both ends of the lower shell 7 and the upper shell 8 are respectively provided with a groove, each groove is embedded with a waterproof rubber pad 9.

Both the lower shell 7 and the upper shell 8 are respectively provided with a limit component, each limit component includes two oppositely arranged sleeves 10. A vertical rod 11 is rotatably connected to one sleeve 10, an end of each vertical rod 11 away from the sleeve 10 is fixedly connected to a baffle 12, the baffle 12 is inclined.

The working principle and beneficial effect of the above technical solution are as follows: the lower shell 7 is first moved to the lower part of the power extension line connector, then a line body is inserted on the lower shell 7 and a corresponding waterproof rubber pad 9, and at the same time, the line body is inserted in the lower shell 7 and into a gap between two baffles 12 at a corresponding position. Then, the upper shell 8 is covered to close the lower shell 7 and the upper shell 8 and protect the power extension line connector. The waterproof rubber pads 9 at both ends of the lower shell 7 and the upper shell 8 are pressed together in pairs, further reducing the gap between the line body and the corresponding waterproof rubber pad 9, effectively preventing external water and dust from invading the inside of the line body through the power extension line connector. The inclined baffle 12 can limit a movement trajectory of the extension component. At the same time, when the baffle 12 is compressed by the power extension line connector, two oppositely arranged baffle 12 will rotate in a small range, further clamping the line body to avoid frequent collisions between the shell and the power extension line connector, causing unnecessary losses and extending the service life of the power extension line.

In an embodiment, a connection position between the lower shell 7 and the upper shell 8 is made of a hard but flexible material.

The working principle and beneficial effect of the above technical solution are as follows: by providing the connection position between the lower shell 7 and the upper shell 8 with as a hard but flexible material, the connection position between the two is made flexible. While ensuring that the connection position can be freely opened and closed, this connection method can also greatly reduce the weight of the entire protection box and improve the sealing of the protection box.

In an embodiment, the upper shell 8 is hinged with multiple buckles 13, and the lower shell 7 is provided with a slot corresponding to the number of buckles 13.

The working principle and beneficial effect of the above technical solution are as follows: after closing the lower shell 7 and the upper shell 8, multiple buckles 13 are pulled to respectively engage with the corresponding slots, and the lower shell 7 can be locked relative to the upper shell 8, further improving the stability of the protective components.

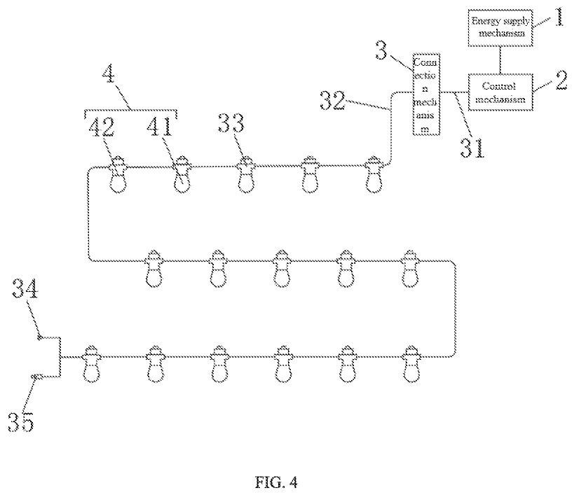

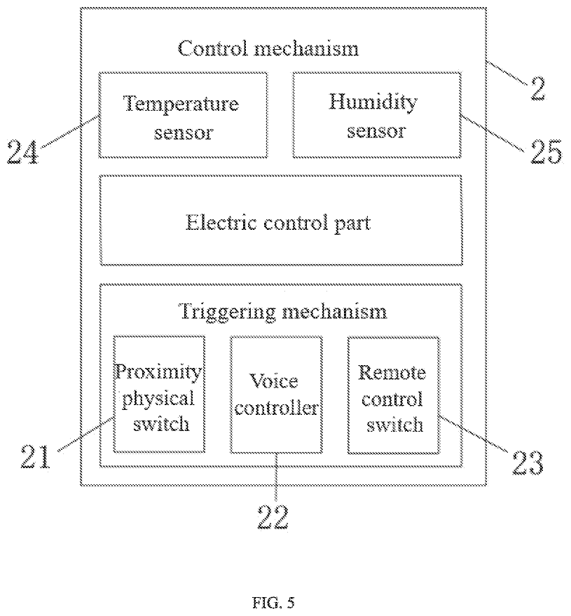

As shown in FIGS. 4 and 5, an embodiment of the present disclosure further provides a solar outdoor decorative lamp group including an energy supply mechanism 1, a control mechanism 2, a connection mechanism 3, and an execution mechanism 4. The energy supply mechanism 1 includes a photovoltaic panel and a battery that continuously provide power to the decorative lamp group, the battery is provided with a topological charging interface.

The control mechanism 2 includes a triggering mechanism and an electrical control part for turning on the photovoltaic panel and battery. The triggering mechanism includes a proximity physical switch 21, a voice controller 22, and a remote-control switch 23. After any one of the proximity physical switch 21, the voice controller 22, and the remote control switch 23 is triggered, the electrical control part controls the execution mechanism 4 to start or stop.

The connection mechanism 3 includes a main connection line 31 and multiple branch connection lines 32. An end of the main connection line 31 is connected to the control mechanism 2, and the other end of the main connection line 31 is connected to a corresponding branch connection line 32 through an extension assembly. The connection mechanism 3 further includes one or more T-shaped interfaces 33 that connect the branch connection lines 32 in pairwise.

The execution mechanism 4 includes multiple light-emitting elements 41, a connection end of each light-emitting element 41 is provided with a connector 42 that is compatible with an unconnected end of the T-shaped interface 33.

The working principle and beneficial effect of the above technical solution are as follows: the entire lamp group is firstly powered by the energy supply mechanism 1, including the photovoltaic panel and battery. Under a normal condition, power is generated by the photovoltaic panel during the day to supply power to the entire lamp group. On rainy or cloudy days or at night, when the photovoltaic power is insufficient, power is supplied to the lamp group by the battery through providing the main connection line 31 and several branch connection lines 32, by cooperating with the extension assembly, the energy supply mechanism 1 can be connected to multiple lamp groups at the same time. Under a coordination of providing with temperature sensor 24 and humidity sensor 25, the temperature and humidity thresholds can be adjusted according to the working environment and conditions of the entire lamp group system. When the temperature and humidity reach the threshold, the electric control department can cooperate to turn off the execution mechanism 4 to ensure the stability of the lamp group operation. Through the proximity physical switch 21, the voice controller 22 and the remote-control switch 23 can control the entire lamp group in multiple ways. The proximity physical switch 21 can directly turn on or off the system. The voice controller 22 can be controlled through voice at close range, while the remote-control switch 23 can be remotely controlled, rendering it more intelligent to turn on or off the lamp group. By connecting multiple T-shaped interfaces 33 and corresponding connectors 42, different types of light-emitting elements 41 can be connected, the voice controller 22, the temperature sensor 24, and the humidity sensor 25 are all existing technologies that play a decorative role, and their working principles will not be described in detail.

In an embodiment, the energy supply mechanism 1 is further provided with a light automatic tracking module to keep a rotation of the photovoltaic panel in a same direction and frequency with the sun.

The working principle and beneficial effect of the above technical solution are: the light automatic tracking module includes a photosensitive sensor installed on the photovoltaic panel, and is driven by a motor to form a movable mechanism, so that the photovoltaic panel can follow a motion trajectory of the sun and rotate at the same frequency under sufficient light, thereby improving a photovoltaic conversion efficiency of the photovoltaic panel.

In an embodiment, the extension assembly includes a male plug 5 installed at an end of the main connection line 31 away from the control mechanism 2, and a female plug 6 installed at an end of the branch connection line 32 near the male plug 5. The male plug 5 and the female plug 6 are plugged together.

The working principle and beneficial effect of the above technical solution are as follows: due to a large number of precision instruments in the control mechanism 2, they need to be installed in relatively safe positions. The extension assembly can extend a connection length between the control mechanism 2 and the branch connection line 32, allowing the control mechanism 2 to have more installation positions and a longer distance to adapt to various installation needs in actual use.

In an embodiment, the control mechanism 2 further includes a temperature sensor 24. When the temperature sensor 24 determines that a temperature exceeds a reasonable range, the electronic control part controls the execution mechanism 4 to turn off.

The working principle and beneficial effect of the above technical solution are that temperature sensor 24 can monitor a temperature change during system operation in real time. Once the temperature in the control mechanism 2 exceeds a reasonable threshold, the system will be immediately shut down, thereby improving the safety of the system.

In an embodiment, control mechanism 2 further includes a humidity sensor 25. After the humidity sensor 25 determines that a humidity exceeds a reasonable range, the electrical control part controls the execution mechanism 4 to turn off.

The working principle and beneficial effect of the above technical solution are that humidity sensor 25 can monitor a humidity change during system operation in real time. Once the humidity inside control mechanism 2 exceeds a reasonable threshold, the system will be immediately shut down and put into use after maintenance by staff, thereby extending the service life of the system.

In an embodiment, a waterproof plug 34 or an extension joint 35 is installed at an end of the branch connection line 32 away from the main connection line 31, and the male plug 5 is a high-voltage to low-voltage connector.

The working principle and beneficial effect of the above technical solution are as follows: after an installation of the entire lamp group, a waterproof plug 34 can be installed at an end of the branch connection line 32 to eliminate safety hazards. Different types of lamp strips can also be connected through the extension joint 35 to further enhance the practicality of the system. By selecting the male plug 5 as the high-voltage to low-voltage joint, the risk of electric shock can be reduced, and the safety of the system can be further improved.

In an embodiment, the light-emitting element 41 is a light bulb or a light string.

The working principle and beneficial effects of the above technical solution are as follows: it should be noted that the light-emitting element 41 adapted to this system include but are not limited to the light bulb or the light string. Other light-emitting element 41 with decorative effects can also be adapted, and the connector 42 can be replaced according to an actual usage need, further improving the practicality of this device.

### Working Principle and Usage Process

After the system is started, the entire lamp group is first powered by the energy supply mechanism 1, including the photovoltaic panel and battery. Under a normal condition, power is generated by the photovoltaic panel during the day, and the entire lamp group is powered by the battery at night. On cloudy or rainy days or when the photovoltaic power is insufficient at night, the lamp group is powered by the battery. By providing with the main connection line 31 and several branch connection lines 32, combined with an extension assembly, the energy supply mechanism 1 can be connected to multiple lamp groups at the same time. In addition, with a cooperation of a temperature sensor 24 and a humidity sensor 25, temperature and humidity thresholds are adjusted according to the working environment and conditions of the entire lamp group system. When the temperature and humidity reach the threshold, the electric control part cooperates to turn off the execution mechanism 4 to ensure an operation of the lamp group. The stability of the entire lamp group can be controlled in multiple ways through the proximity physical switch 21, the voice controller 22, and the remote-control switch 23. The proximity physical switch 21 can directly turn on or off the system, the voice controller 22 can control through voice at close range, and remote-control switch 23 can be remotely controlled, rendering it more intelligent to turn on or off the lamp group. Where, the voice controller 22, the temperature sensor 24 and the humidity sensor 25 are both existing technologies, and their working principles will not be described in detail. Firstly, the male plug 5 and female plug 6 that are plugged together are placed in a middle of the lower shell 7. Then, the main connection line 31 and the branch connection line 32 are inserted into the corresponding waterproof rubber pad 9. At the same time, the line bodies of the main connection line 31 and the branch connection line 32 are inserted into a gap between the two baffles 12 at a corresponding position. Then, the upper shell 8 is covered to close the lower shell 7 and the upper shell 8 and protect the extension assembly. The waterproof rubber pads 9 at both ends of the protective component are fitted together in pairs, further narrowing the gap between the body of the main connection line 31 and the corresponding waterproof rubber pad 9 of the branch connection line 32, effectively preventing external water and dust from invading the interior of the male plug 5 and female plug 6. The inclined baffle 12 can limit a movement trajectory of the male plug 5 and female plug 6. At the same time, when the baffle 12 is compressed by the male plug 5 or female plug 6, an oppositely arranged baffle 12 will rotate in a small range, further clamping the body of the main connection line 31 or the branch connection line 32, to avoid frequent collisions between the shell of the protective component and the male plug 5 or female plug 6, resulting in unnecessary losses, and to ensure the normal operation of the system, the extension assembly can extend a connection length between control mechanism 2 and branch connection line 32, allowing for more installation positions and farther distances for control mechanism 2 to meet various installation needs during actual use.

The present disclosure can effectively prevent water and dust from entering the connection between male plug 5 and female plug 6 in most cases by providing with a protective box at the connection position, thereby extending the service life of the system.

It should be noted that in this description, relational terms such as first and second are only used to distinguish one entity or operation from another entity or operation, and do not necessarily require or imply any actual relationship or order between these entities or operations. Moreover, terms “including”, “comprising”, or any other variation thereof are intended to encompass non-exclusive inclusion, such that a process, method, item, or device that includes a series of elements not only includes those elements, but also includes other elements that are not explicitly listed, or also includes elements inherent to such process, method, item, or device.

Although embodiments of the present disclosure have been shown and described, it can be understood by those skilled in the art that multiple variations, modifications, substitutions, and variations can be made to these embodiments without departing from the principles and spirit of the present disclosure. The scope of the present disclosure is limited by the claims and their equivalents.

What is claimed is:

1. A protection box for a power extension line, comprising a lower shell (7) and an upper shell (8), wherein the lower shell (7) is movably connected to the upper shell (8), both ends of the lower shell (7) and the upper shell (8) are provided with a groove, each groove is embedded with a waterproof rubber pad (9);
both the lower shell (7) and the upper shell (8) are respectively provided with a limit component, each limit component comprises two oppositely arranged sleeves (10), a vertical rod (11) is rotatably connected to one sleeve (10), an end of each vertical rod (11) away from the sleeve (10) is fixedly connected to a baffle (12), the baffle (12) is inclined.

2. The protection box for a power extension line according to claim 1, wherein a connection position between the lower shell (7) and the upper shell (8) is made of a hard but flexible material.

3. The protection box for a power extension line according to claim 2, wherein the upper shell (8) is hinged with multiple buckles (13), and the lower shell (7) is provided with a slot corresponding to the number of buckles (13).

4. A solar outdoor decorative lamp group with the protection box for a power extension line according to claim 1, comprising an energy supply mechanism (1), a control mechanism (2), a connection mechanism (3), and an execution mechanism (4), wherein the energy supply mechanism (1) comprises a photovoltaic panel and a battery that continuously provide power to the decorative lamp group, the battery is provided with a topological charging interface;
the control mechanism (2) comprises a triggering mechanism and an electronic control part for turning on the photovoltaic panel and battery, the triggering mechanism comprises a proximity physical switch (21), a voice controller (22), and a remote-control switch (23); after any one of the proximity physical switch (21), the voice controller (22), and the remote-control switch (23) is triggered, the electronic control part controls the execution mechanism (4) to start or stop;
the connection mechanism (3) comprises a main connection line (31) and multiple branch connection lines (32), an end of the main connection line (31) is connected to the control mechanism (2), the other end of the main connection line (31) is connected to a corresponding branch connection line (32) through an extension assembly, the connection mechanism (3) further comprises one or more T-shaped interfaces (33) that connect the branch connection line (32) in pairwise;
the execution mechanism (4) comprises multiple light-emitting elements (41), a connection end of each light-emitting element (41) is provided with a connector (42) adapted to an unconnected end of the T-shaped interface (33).

5. The solar outdoor decorative lamp group according to claim 4, wherein the energy supply mechanism (1) is further provided with a light automatic tracking module to keep a rotation of the photovoltaic panel in a same direction and frequency with the sun.

6. The solar outdoor decorative lamp group according to claim 4, wherein the extension assembly comprises a male plug (5) installed at an end of the main connection line (31) away from the control mechanism (2), and a female plug (6) installed at an end of the branch connection line (32) near the male plug (5), wherein the male plug (5) and the female plug (6) are plugged together.

7. The solar outdoor decorative lamp group according to claim 4, wherein the control mechanism (2) further comprises a temperature sensor (24), when the temperature sensor (24) determines that a temperature exceeds a reasonable range, the electric control part controls the execution mechanism (4) to turn off.

8. The solar outdoor decorative lamp group according to claim 4, wherein the control mechanism (2) further comprises a humidity sensor (25), and after the humidity sensor (25) determines that a humidity exceeds a reasonable range, the electric control part controls the execution mechanism (4) to turn off.

9. The solar outdoor decorative lamp group according to claim 6, wherein a waterproof plug (34) or an extension joint (35) is provided at an end of the branch connection line (32) away from the main connection line (31), the male plug (5) is a high-voltage to low-voltage joint.

10. The solar outdoor decorative lamp group according to claim 4, wherein the light-emitting element (41) is a light bulb or a light string.
